(19) United States
(12) Patent Application Publication
(10) Pub. No.: US 2015/0095359 A1
(43) Pub. Date: Apr. 2, 2015

(54) Volume Reducing Classifier

(71) Applicant: Roke Manor Research Limited, Romsey (GB)

(72) Inventor: Neil Duxbury, Romsey (GB)

(21) Appl. No.: 14/485,862

(22) Filed: Sep. 15, 2014

(30) Foreign Application Priority Data
Sep. 27, 2013 (GB) 1317217.6

(51) Int. Cl. G06F 17/30; G06N 99/00; G06N 5/04

(52) U.S. Cl. CPC G06F 17/30985; G06F 17/30386; G06N 5/047; G06N 99/005
USPC 707/758

(57) ABSTRACT

A method and apparatus for searching data for a pattern, the data being sent over a data-communication network, from a service, using a communication protocol. The method comprises the steps of receiving the data and generating a fingerprint associated with the data, the format of the fingerprint being based on the communication protocol and the content of the fingerprint being based on at least one characteristic of the data. The method also comprises the steps of identifying the data as belonging to a particular service and determining whether the data contains the particular pattern by comparing the fingerprint to a previously generated matching fingerprint. The method also comprises the steps of, if no previously generated matching fingerprint exists, selecting a pattern matching algorithm from a plurality of pattern matching algorithms based on the identified service and searching the data using the selected pattern matching algorithm.

### TECHNICAL FIELD

Various aspects relate to the field of string matching, and more particularly to the field of increasing the efficiency of string matching by pre-classifying data in order to reduce the volume of work required to search the data.

### BACKGROUND

String matching problems range from the relatively simple task of searching a single text for a string of characters to searching a database for approximate occurrences of a complex pattern. A string is a sequence of characters over a finite alphabet Σ. For instance, ATCTAGAGA is a string over Σ={A, C, G, T}. The string matching problem is to find all the occurrences of a string p, called the pattern, in a large string T on the same alphabet, called the text. Given the strings x, y and z, it can be said that x is a prefix of xy, a suffix of yx and a factor of yxz.

This problem may be extended in a natural way to search simultaneously for a set of strings P={p¹, p² . . . p^{r}}, where each pⁱ is a string pⁱ=p₁ⁱp₂ⁱ . . . p^{u}ₘᵢ over a finite character set Σ. Denote by |P| the sum of the lengths of the strings in P. As before the search is done in a text T=t₁t₂ . . . tₙ. Strings in P may be factors, prefixes, suffixes or even the same as others. For example if a search is carried out for the set {ATATA, TATA} each time an occurrence of ATATA is found, an occurrence of TATA is also found. Hence the total number of occurrences can be r×n. In the multi string case, of interest is the reporting of all pairs (i, j) such that t_{j-|pi|+1 . . .} tⱼ is equal to pⁱ.

Approximate string matching, also called “string matching allowing errors” is the problem of finding a pattern in a text T when a limited number k of differences is permitted between the pattern and its occurrences in the text. The complexity of string matching problems increases when the number of data to be searched increases, as well as when the value of k increases.

Typically, know pattern matching methods tend to be design for the general case where a single, generalised algorithm solves all features of the match problem, and advances in this field tend to concentrate on the optimisation of the search part of the algorithm and assume that the data that the search executes on is arbitrary and essentially random.

Known search methods generally make use of sparsely populated data structures that exhibit a random memory access pattern. As a consequence, the performance of known methods is predominantly determined by memory bandwidth. Performance can also be increases by increasing processor clock speed. However, as integration limits are reached this route becomes more difficult and authors are instead moving to a data parallel paradigm and multi processing. A problem with this approach is it increases system complexity as an increasing numbers of processing elements is costly. An alternative is the development of more efficient algorithms.

### BRIEF SUMMARY

Various embodiments described herein solve the problems associated with the prior art by providing a method of searching data for a pattern, the data being sent over a data-communication network, from a service, using a communication protocol, the method comprises: receiving the data; generating a fingerprint associated with the data, the format of the fingerprint being based on the communication protocol and the content of the fingerprint being based on at least one characteristic of the data; identifying the data as belonging to a particular service; determining whether the data contains the particular pattern by comparing the fingerprint to a previously generated matching fingerprint; and if no previously generated matching fingerprint exists, selecting a pattern matching algorithm from a plurality of pattern matching algorithms based on the identified service; and searching the data using the selected pattern matching algorithm.

Preferably, the step of identifying the particular service includes the steps of: extracting an indication of the service from the data; or generating a unique identifier associated with the service using information extracted from the transactions received from the service.

Preferably, at least one pattern matching algorithm of the plurality of pattern matching algorithms includes a parsing step and a string matching step.

Preferably, the method further comprises the steps of: storing the fingerprint associated with the data together with associated metadata, the metadata including an indication of the result of the searching step, the fingerprint being stored in memory means comprising a plurality of fingerprints and associated metadata; and wherein the step of determining whether the data contains the pattern by comparing the fingerprint to previously generated fingerprints includes comparing the fingerprint to the fingerprints stored in the memory means.

Preferably the method further comprises the step of: if a previously generated matching fingerprint is found, updating the metadata associated with the fingerprint to increment the number of matching fingerprints found by 1.

Preferably, the memory means is a Look Up Table.

Preferably, if a determination is made that the data contains the pattern, the data is stored for future reference; and if a determination is made that the data does not contain the pattern, the data is discarded.

Preferably, the step of identifying the data as belonging to a particular service includes the step of identifying that the data belongs to an unknown service, and the step of selecting a pattern matching algorithm from a plurality of pattern matching algorithms based on the identified service further includes the step of selecting a generalised search algorithm if the data is identified as belonging to an unknown service.

Various embodiments also provides an apparatus for searching data for a pattern, the data being sent over a data-communication network, from a service, using a communication protocol, the apparatus comprises: data receiving means arranged to receive the data; fingerprint generating means arranged to generate a fingerprint associated with the data, the format of the fingerprint being based on the communication protocol and the content of the fingerprint being based on at least one characteristic of the data; identification means arranged to identify the data as belonging to a particular service; pattern determination means arranged to determine whether the data contains the particular pattern by comparing the fingerprint to a previously generated matching fingerprint; and pattern matching selection means arranged to, if no previously generated matching fingerprint exists, select a pattern matching algorithm from a plurality of pattern matching algorithms based on the identified service; and searching means arranged to search the data using the selected pattern matching algorithm.

Preferably, the apparatus further comprises: storing means arranged to store the fingerprint associated with the data together with associated metadata, the metadata including an indication of the result of the searching step, the fingerprint being stored in a Look Up Table comprising a plurality of fingerprints and associated metadata; and fingerprint comparing means arranged to compare the fingerprint to the fingerprints stored in the Look Up Table.

Preferably, the apparatus further comprises: metadata updating means arranged to, if a previously generated matching fingerprint is found, updating the metadata associated with the fingerprint to increment the number of matching fingerprints found by 1.

Preferably, the apparatus further comprises: a data router, the data router being arranged to: if a determination is made that the data contains the particular pattern, store the data for future reference; and if a determination is made that the data does not contain the particular pattern, discarded the data.

Preferably, the identification means is further arranged to identify that the data belongs to an unknown service, and pattern matching selection means is further arranged to select a generalised search algorithm if the data is identified as belonging to an unknown service by the identification means.

Various embodiments further comprise a computer program product for a data-processing device, the computer program product comprising a set of instructions which, when loaded into the data-processing device, causes the device to perform the steps of the aforementioned method.

As will be appreciated, various embodiments provide several advantages over the prior art. For example, various embodiments take advantage of the fact that, in practical use cases, the data to be processed is seldom arbitrary and usually contains properties that enable the search problem to be recast into a number of simpler problems against which a collection of algorithms can be applied. In this case the algorithms may offer more optimum performance than the single monolithic algorithms as they are better matched to different aspects of the overall problem such that the aggregate performance is higher than that obtained in the generalised case.

Moreover, various embodiments reduce the volume of work that needs to be performed by computationally expensive stages. Consequently, the aggregate performance of the embodiments is higher relative to the systems and methods that employ a more general solution.

In order to achieve the advantages of the various embodiments, data which is to be processed is classified and routed to an appropriate search method for the data type. The pre-classification volume reducing classifier described herein provides a set of simple algorithms that are used to pre-classify the data to either identify data that has already been processed or to route the incoming data to an appropriate algorithm for that data type.

Various embodiments are particularly advantageous when processing input data that has a particular characteristic such that it is best to process it with a particular class of algorithm. For example HTTP, HTML, JSON, XML and JavaScript are highly structured. Processing these formats using a generalised search algorithm is less efficient that processing them with bespoke parsers.

By classifying this type of content a priori to the search process, then the most appropriate method can be used to process the data such that the aggregate performance of the system is increased.

Various embodiments are also particularly advantageous when processing input data that has a high degree of replication, an example of this is internet data. Here a group of users may download the same webpage. If Deep Packet Inspection (DPI) is performed on this data the DPI platform will perform unnecessary re-work as it will apply the same general search algorithm to multiple copies of the same data.

The fact that the data comes from different users is irrelevant in regard to the search problem as the same set of results will be generated for each instance of the data. Thus, rather than scan all instances of this data an alternative is to generate a fingerprint for the data. The fingerprint can then be used to recognise when the data has been seen before and prevent its reprocessing.

### DESCRIPTION OF THE DRAWINGS

Some embodiments of apparatus and/or methods are now described, by way of example only, and with reference to the accompanying drawings, in which:

FIG. 1 is a schematic block diagram of a processing architecture in accordance with an embodiment;

FIG. 2 is a flow chart representing a data-processing method in accordance with one embodiment;

FIG. 3 is a flow chart representing the steps performed by a router in accordance with one embodiment; and

FIG. 4 is a schematic diagram of a data processing system which can be used to implement various embodiments.

### DETAILED DESCRIPTION

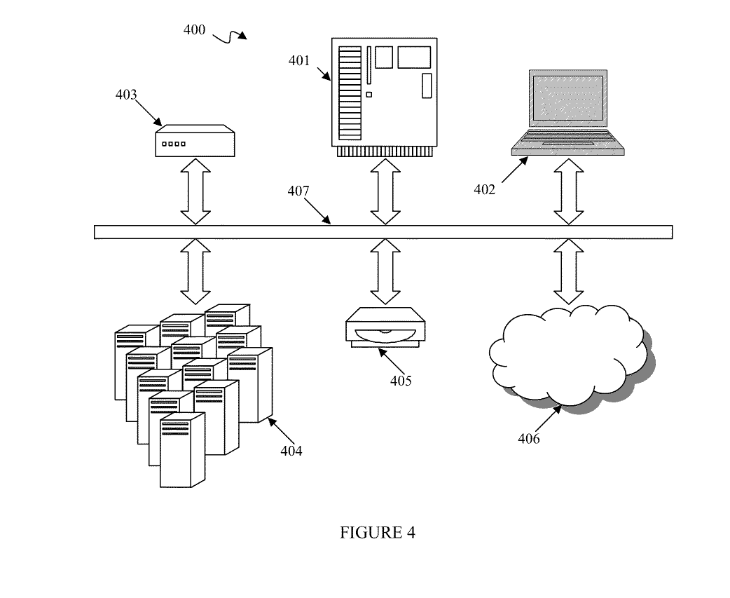

FIG. 4 is a schematic diagram of a data processing system 400 suitable for implementing various embodiments. The data processing system 400 comprises a processing unit 401, such as a central processing unit (CPU), an input/output device 402, such as a terminal including a screen and a keyboard and a local memory unit 403, such as hard drive. As will be appreciated, in some embodiments, the processing unit 401, the input/output device 402 and the local memory unit 403 can all be incorporated into a single multipurpose desktop or laptop computer.

In some embodiments, the data processing system 400 also comprises a communication channel 407 for ensuring data communication between elements of the data processing system 400. It will be appreciated that the communication channel 407 can be provided by a local communication channel, such as a Universal Serial Bus (USB), by a telecommunication channel, such as a Local Area Network (LAN) or a Wide Area Network (WAN), or a combination thereof. In some embodiments, the data processing system 400 also comprises a remote memory device 405 for off-site recording of analysed data and/or a remote storage facility 404 for the remote storage of analysed data. Finally, in some embodiments, data processing system 400 can also be connected to a computer network 406, such as a Local Area Network (LAN) or the Internet.

The aforementioned data processing system 400 may be used to receive a data stream at its input. The data stream may consist of a set of records or may consist of a set of documents that have been reconstituted from a low level packet processing pipeline. It may also consist of raw packets taken from a communications link, or of any other form or type of computer-readable data.

The input data is then classified and searched within the data processing system 400 and the results of the search are recorded in any of the local memory unit 403, the remote memory device 405 and the remote storage facility 404. The results of the search may also be used to decide whether the associated data is stored for further analysis. The results of the search may further be used to decorate the data with meta-data that is subsequently used to process the data further.

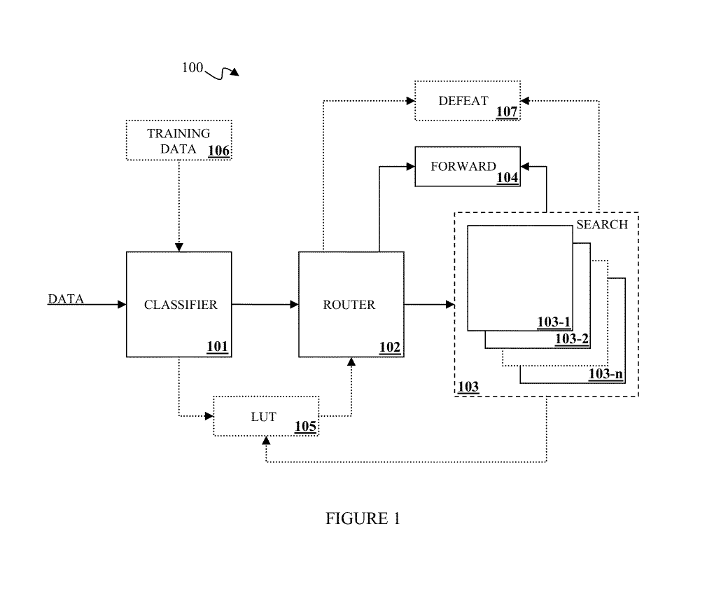

FIG. 1 shows a processing device 100 in accordance with one embodiment. The processing device 100 includes a classifier 101, a router 102, a search block 103 and a forward block 104. The classifier 101 applies a classification function to the data that is used to decide how subsequent processing will be performed. The classifier 101 may be pre-configured with training data 106 that define pre-compiled signatures which can be used by the classifier 101.

The classifier 101 labels the data with some form of meta-data which is derived from the data type. The labelled data is then passed to the router 102 which directs the data to an appropriate processing function 103-1 to 103-n in the search block 103, or forwards it with any associated match meta-data to the forward block 104.

As used herein, the term “forward” is defined as keeping, storing or using data which may be of interest in any way, while the term “defeat” is defined as deleting or discarding unwanted data.

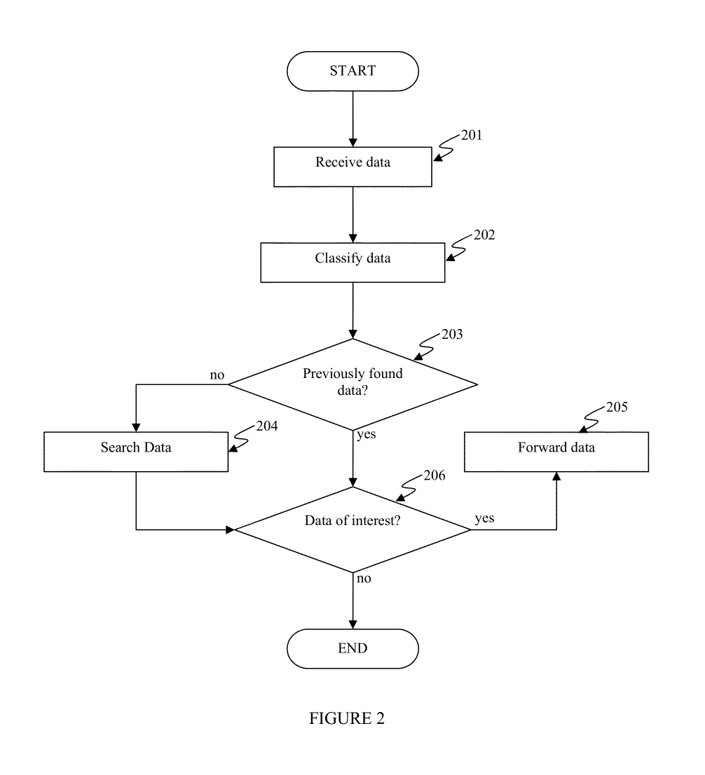

A method in accordance with one embodiment is shown in FIG. 2. The method described in FIG. 2 starts when data is received by classifier 101 at step 201. The data is classified at step 202 using an appropriate algorithm and the classifier classifies the data into a particular class of data. A determination is also made as to whether the data has been found before at step 203. If the data has been found before, a determination is made at step 206 as to whether or not the data is of interest. If at step 206 a determination is made that the data is not of interest, the method will end. Alternatively, the data can be deleted or sent to another data processing entity to be used further. If at step 206 the data is determined to be of interest, the data is kept by forwarding it, at step 205, to an appropriate device, such as, for example, remote memory device 405, remote storage facility 404, or any other appropriate device by way of communication channel 407 and/or computer network 406.

If, at step 203, a determination is made that the data has not been previously seen, router 102 routes the data to a particular processing function 103-1 to 103-n of the search block 103. Which processing function 103-1 to 103-n the router 102 chooses depends on the class of data found by the classifier 101 in step 202. Once the data is received by the appropriate processing function 103-1 to 103-n, the data is searched by the appropriate processing function 103-1 to 103-n at step 204.

Typically, the appropriate processing function 103-1 to 103-n applies a pattern matching technique to the data. The result of the search can be a set of matches against the data or the indication of a mismatch condition. Each processing function 103-1 to 103-n of the search block 103 contains one or more search routines which can be based on known pattern matching algorithms such as, for example, those described by Knuth Morris Pratt, Boyer Moore, Commentz Walter, Aho and Corasick. Alternatively, a processing function 103-1 to 103-n can consist of the identification and extraction of parameter data, leaving the mark up or syntactic data behind, or, the extraction of mark up or syntactic data, leaving the parameter data behind, or a combination of both. This type of operation can be efficiently performed using a parser rather than a generalised search algorithm.

For some types of information, the mark-up/syntactic data will be extracted by essentially using a parser to pull out the mark up or TYPE data and use this to describe to content. For example, in a JSON document, TYPE data is identified and extracted, and the parameter data is discarded. Another example is a URL, in which example the URL is decomposed into a set of TYPEs, and parameter data is discarded. A similar mechanism is used for Cookies, www-form-url-encoding, HTML, XML and most other forms of structured data.

Using various embodiments, it is also possible to extract parameter data when it takes a particular format, for example an email address, a username, a name or a number. In this case the mark up is sampled around the identified entity either by extracting a fixed number of characters or by parsing the mark up around the entity which again gives us a collection of TYPE values, as described below.

A third mechanism of various embodiments is to detect TYPEs that match trigger words such as ‘email’, ‘name’ etc which are defined in a dictionary.

A fourth mechanism of various embodiments does use parameter data, for example HTTP. Here the HTTP header field TYPEs are known a priori and it is their values that are used to represent the data for particular HTTP field types.

Using various embodiments, it is also possible to mix any number of the above techniques. For HTML/JavaScript, the invention identifies and strips out all of the parameter data and forms a code skeleton from the mark-up and syntax that remains. For HTML, it is possible to identify and extract all the URLs and then subsequently decompose the URLs into a set of TYPEs discarding the parameter data, and extract the labels associated with interface elements such as buttons, text boxes, forms etc. In this instance we would combine the elements derived from mark-up, syntax and parameter information into the fingerprint used to describe the associated data.

Finally, it is also possible to look for keywords—generalised string search and seek to derive a collection of TYPE's from the data that surrounds the words that have been found, as described below. In general the TYPE information is derived from the mark up or the syntax that the parameter data is found in and this is used as the basis for the fingerprint

Once the data is searched at step 204 using the appropriate processing function 103-1 to 103n, a determination is made at step 206 whether the data is of interest. This is done by looking at whether the search step 204 resulted in a match. If the search step resulted in a match, the data is kept by forwarding it, at step 205, to an appropriate device, such as, for example, remote memory device 405, remote storage facility 404, or any other appropriate device by way of communication channel 407 and/or computer network 406. If the search step 204 did not produce a match, the method is terminated and the data is optionally discarded.

In one embodiment of various embodiments, the classifier 101 is configured using protocol fingerprinting. Protocol fingerprinting includes the generation of fingerprints for common data formats. For example, in the case of Hypertext Transfer Protocol (HTTP), the contents of the HTTP fields can be extracted as strings and combined in order to produce a fingerprint common to a service or a transaction, as hereinafter described. Internet cookies can be processed in the same way.

Another example is that of Hypertext Markup Language (HTML), in which an HTML document is re-constituted and a fingerprint is generated by removing all parameter data from the document. The residual is a code skeleton representing the documents mark up. In addition, the set of links embedded within the document is used to form a signature. Here the non parametric fields of the links are extracted and formed into strings. This set of strings is then combined with the skeleton to form the page fingerprint. JavaScript can be treated in a similar fashion to HTML, except that the links are not relevant.

Further examples are JavaScript Object Notation (JSON) and Extensible Markup Language (XML), in which the non-parameter parts of the JSON data and XML data, respectively, can be used to form the fingerprint by concatenating all of the type values into a single string.

Optionally, any of the parameter data fields may also be included in a fingerprint. A fingerprint can also be turned into a hash value to reduce the storage requirements. Classifier 101 can use any combination of the above fields in order to produce a fingerprint. Alternatively, the classifier 101 can also use any of the above fields in isolation in order to produce a fingerprint, or may use a subset of the fields available from each format.

The classifier 101 may be pre-configured using offline training data 106 or the configuration data could be passed back to it at runtime as the data is processed in a negative/positive feedback cycle (not shown). In one embodiment of the invention, the classifier 101 labels the data according to its fingerprint. The fingerprinted data is then passed to the router 102 which then directs the data to an appropriate processing function 103-1 to 103-n in the search block 103, discards it or forwards it with any associated match meta-data.

In one embodiment of the invention, the processing device 100 comprises a Look Up Table (LUT) 105 for use when the classification operation involves maintaining some state on what has been analysed before. The LUT 105 is a dictionary whose key is the fingerprint. Against this key meta-data is stored that identifies whether the data has been analysed before, a record of any hits against that data and/or a field to describe whether the data should be forwarded or defeated (i.e. discarded).

The router 102 can be used to control how the data is processed. The router 102 makes use of data stored within the LUT 105 to decide whether new data is a replication of previously seen data and/or whether new data contains information of interest (i.e. a match). In the case of data not containing information of interest, the data is identified as being a replication of previous content via the fingerprint and the result of the search process (i.e. no match) is cached in the LUT against the fingerprint.

The forward block 104 is a process which maintains a record of the results of a search. If the search resulted in a match, the data is kept by forwarding it to an appropriate device, such as, for example, remote memory device 405, remote storage facility 404, or any other appropriate device by way of communication channel 407 and/or computer network 406.

The defeat block 107 is a process which handles data that has been identified as being not of interest. This classification of data can also be associated with a fingerprint and used to avoid analysing data that has previously been recognised as not containing information of interest to the search (e.g. it does not contain any search hits).

The search block 103 applies some set of pattern matching techniques to the data. Each of processing functions 103-1 to 103-n can incorporate one or more pattern matching techniques, along with other data processing techniques such as, for example, parsing. The result of the search can be a set of matches against the data or the indication of a mismatch condition. In both instances the result of the operation is sent by the search block 103 to the LUT 105 so that it can be used by the router to direct subsequent processing.

The meta-data extracted by the search routine includes whether there is a hit or not and/or the set of matches or a reference to another result that had the same matches. For generalised searches, the processing functions 103-1 to 103-n of the search block 103 can contain any number of standard pattern matching algorithm, such as, but not limited to, those described by Knuth Morris Pratt, Boyer Moore, Commentz Walter, Aho and Corasick.

For particular internet transmission formats, it is more efficient to process those formats using a parser rather than a generalised search function. In general search functions are optimised to perform well for arbitrary data and arbitrary patterns. However, many formats within the internet have strict formatting rules. These include HTTP, HTML, XML, JSON, JavaScript, Internet cookies, x-www-form-url-encoding. For these types an alternative way of searching the data is to identify and extract the parameter data leaving the mark up or syntactic data behind. This type of operation can be efficiently performed using a processing function 103-1 to 103-n which includes a parser rather than a generalised search algorithm.

Most generalised search algorithms' practical performance is dominated by memory bandwidth, as their memory access profile is essentially random. Thus, the search rate is usually defined by how quickly they can access their look up tables in memory. For a parser, the memory access profile is quite different and the processing tends to involve fewer memory lookups and is more tightly bound to the CPU core within a computer system. Thus, although the operations of a parser may be more complex, the fact that it makes fewer memory accesses means that it can run faster overall than the generalised search method.

Thus, in various embodiments, the functionality of a generalised search method can be replaced by a parser that extracts the parameter data and then performs a lookup into a dictionary in order to identify data of interest. In order for this approach to be successful, a pre-processing stage is required in order to route the data to an appropriate parser. This routing behaviour is performed by the routing block with the assistance of the classifier stage. In the case where a parser cannot be identified for the data in the classifying stage, the device can use one or more of the generalised search functions which can form part of the processing functions 103-1 to 103-n.

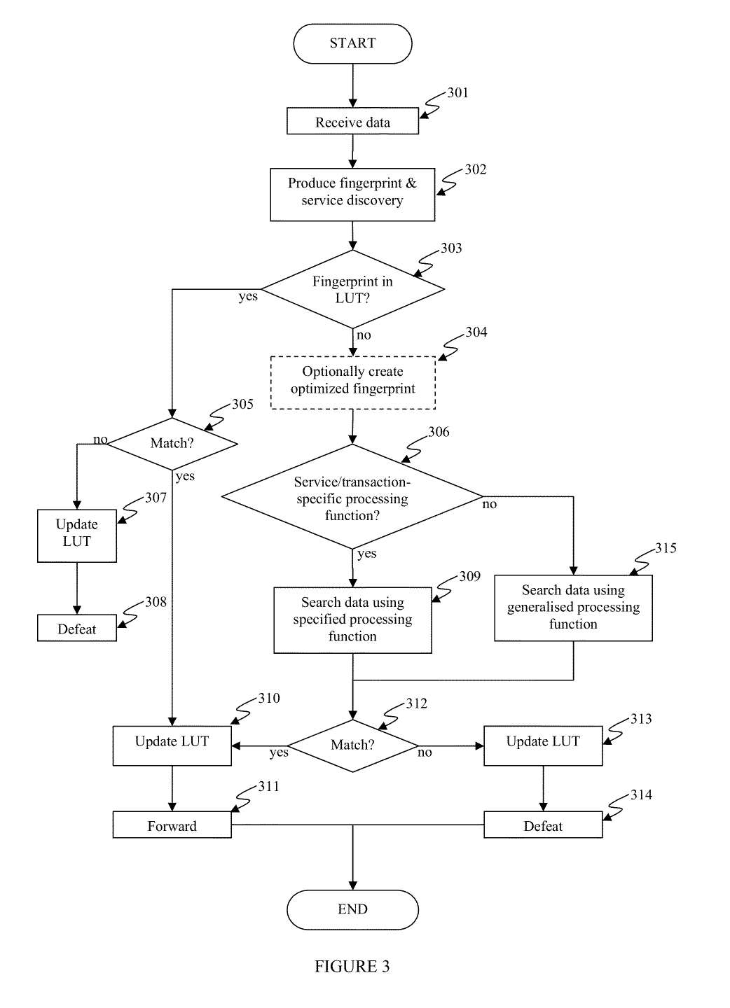

FIG. 3 shows a flow chart representing the steps performed by a router in accordance with one specific embodiment. In step 301, the classifier 101 receives a data stream. The data stream may consist of a set of records or may consist of a set of documents that have been reconstituted from a low level packet processing pipeline. It may also consist of raw packets taken from a communications link.

In order to facilitate understanding of the invention, the embodiment of FIG. 3 will be described with respect to the specific example of a data stream containing an HTTP session (or part thereof) and other types of information.

In step 302, the classifier uses a part of the data stream, hereafter referred to as “the data”, to produce a protocol fingerprint based on the communication protocol of the data stream.

At step 302, the classifier uses a part of the data to produce a unique fingerprint for that data. The fingerprint can include any combination of parameter and type fields, which are extracted and concatenated into a string. For example, if data is identified as coming from the service www.webmailservice.com, it is possible to create a fingerprint using the value of Content-Type field and the Host field.

The Content-Type field is extracted and represented as a string, and the Host field is extracted and a set of strings consisting of the full host and the sub-domains within the host are collected. This metadata is then used to create a string which will be used to create the fingerprint. Alternatively, a hash of the created string can be used to create the fingerprint. In one embodiment, the string or the hash of the string will constitute the fingerprint. As will be appreciated by the skilled reader, there are a number of different fingerprints which can be created once a determination is made as to the protocol of the data stream.

Accordingly, in the above examples, the fingerprint created at step 302 can consist of a unique string comprising any of the service/transaction, the entity type field, and the entity value, or any combination thereof. This will now be described with respect to the following example, in which the following HTTP POST request is received by the invention.

POST
/config/login;_ylt=12345?logout=1&.direct=2&.done=
http://bt.mailservicesite.com&.src=cdgm&.partner=bt&.intl=uk&.lang=
en-GB
Host: mail.mailservicesite.com
User-Agent: Mozilla
Cookie: B=12345&b=5678&d=ABCD
Content-Type: application/json
{“rs”:”1”,”email”:”foo@mailservicesite.com”,”loggers”:”true”}

An initial fingerprint created for the above transaction could be as follows:
HTTP-METHOD: /config/login
HTTP-METHOD: _ylt
HTTP-METHOD: logout
HTTP-METHOD: .direct
HTTP-METHOD: .done
HTTP-METHOD: .src
HTTP-METHOD: .partner
HTTP-METHOD: .intl
HTTP-METHOD: .lang
HTTP-HOST: mail.mailsite.com
HTTP-USER-AGENT: Mozilla
HTTP-COOKIE: B
HTTP-COOKIE: b
HTTP-COOKIE: d
JSON: rs
JSON: email
JSON: loggers
TETRAGRAM: {“rs
TETRAGRAM: “rs”
TETRAGRAM: rs”:
TETRAGRAM: s“:”
TETRAGRAM: “:”1
TETRAGRAM: :“1”
TETRAGRAM:
TETRAGRAM:
TETRAGRAM:
TETRAGRAM: ,“em
TETRAGRAM: “ema
TETRAGRAM: emai
TETRAGRAM: mail
TETRAGRAM: ail”
TETRAGRAM: il”:
TETRAGRAM: l“:”
TETRAGRAM: “,”l
TETRAGRAM: ,“lo
TETRAGRAM: “log
TETRAGRAM: logg
TETRAGRAM: ogge
TETRAGRAM: gger
TETRAGRAM: gers
TETRAGRAM: ers”
TETRAGRAM: rs”:
TETRAGRAM: s“:”
TETRAGRAM: “:”t
   TETRAGRAM: :“tr
TETRAGRAM: “tru
TETRAGRAM: true
TETRAGRAM: rue”
TETRAGRAM: ue”}

The optimized fingerprint, optionally created at step 304, can also be generated at step 302 if the content is recognized as having been seen before. The optimized fingerprint is formed by either taking a subset of the types in order to create the smallest unique fingerprint (i.e. the smallest fingerprint which is not present in the Look Up Table).

For the TETRAGRAM type there is a generalisation to an ngram type, also for the ngram type the raw data would be passed through the training method disclosed in published European patent application EP2485433.

The collection of strings derived from either a single type or the combination of types is then treated as a bag of words. This bag of words can be used to find the transaction in the following ways:
1) Matching all of the strings in the bag ignoring their frequency of occurrence;
2) Matching all of the strings in the bag and taking account of their frequency of occurrence; and
3) Matching all of the strings in the bag and taking account of their frequency of occurrence and their position relative to the start of the transaction.

At step 302, in order to identify the service, there are a number of methods available. An exemplary method is to use the HTTP-HOST type to identify the service. However, it is also possible to use any other type or collection of types within the fingerprint to assert that the content was a particular service. Similarly it is also possible to use this approach to identify a particular transaction within a service.

Another example of how a fingerprint can be generated is that of XML. In particular, the example of:

<result field1 =”1”
field2=2><engagement>hello</engagement><fred>fred</fred>
<barney>barney</barney></result>

In the above example, it is possible to speculatively detect the XML and derive the following fingerprint:
XML: result
XML: field1
XML: field2
XML: engagement
XML: /engagement
XML: fred
XML: /fred
XML: barney
XML: /barney
XML: /result

This is a similar approach to the HTTP example, above, except that there is no HOST field, and so the service is now identified using the collection of strings.

This same approach is used for other types such as HTML and JSON, in these cases all of the attribute data is removed (as has been done above) and a string is formed from the non-attribute data that is then associated with the service/transaction.

It is also possible to perform some correlation at the IP/TCP layer in that if the service is discovered in the client server direction, we then use the reverse IP/TCP tuple to label transactions in the server in the client direction. Similarly if a service is discovered for one set of words, if the same set of words is seen elsewhere it is possible to label that set of words with the same service.

Another example is that of a string of text in which the format is unknown:
From: barnie@mailsite.com
To: fred@mailsite.co.uk
Date: 24/07/2013

In this case, the content type is not known apriori, but it is still possible to derive a fingerprint by constructing TETRAGRAMS (generalisation ngram) around the email addresses, as follows:
From
rom:
ro:
\r\nTo
\nTo:
To:
\r\nDa
\nDat
Date
ate:
te:

This is then passed through the decoder training disclosed in published European patent application EP2485433 and the resultant set of fixed strings is used as the fingerprint.

Yet another fingerprint generation example is described below, in respect of the following HTML document:

<!DOCTYPE html>
<html>
<body>
<title> my first html document </title>
<h1>My First Heading</h1>
<p>My first paragraph.</p>
<p>My second paragraph.</p>
<p>My third paragraph.</p>
<p>My fourth paragraph.</p>
</body>
</html>

A possible fingerprint for this document can be form based only on HTML keywords. In this case the fingerprint would be:
HTML: html
HTML: body
HTML: title
HTML: my first html document
HTML: /title
HTML: hl
HTML: /hi
HTML: 4 p
HTML: 4/p
HTML: /body
In the fingerprint, “4 p” and “4/p” represent 4 instances of the string “p” and 4 instances of the string “/p”. Here the number of hits on each individual string is counted and the result is encoded into the fingerprint.

To identify this fingerprint an HTML parser is used, that looks for the ‘<’ and ‘>’ symbols. On finding these symbols the term contained within are extracted and stored. This continues until the end of the document at which point the fingerprint is compared to the fingerprint store. This method limits the number of accesses to memory search tables to 1 which occurs at the end of the processing. This should be compared to a generalised string search algorithm where several random accesses (potentially 1 for each character in the document) are made to a search table in memory. In practice, system performance is limited by how quickly memory can be accessed, moreover for modern memory (e.g. DDR3), the cost of random memory access typically generated by search algorithms results in non optimum utilisation of the memory interface and limited throughput. This approach expends logical processing resource embodied in a parser to limit the number of accesses to slow memory and hence increases throughput.

As described above, the service determination step can either determine the service by analysing the data directly, or by identifying a unique combination of type fields in a sequence of transactions or within an individual transaction. As will be appreciated, while service determination is made at block 302 in the embodiment shown in FIG. 3, it is not necessary for the service and/or transaction determination to be made at that point. The service and/or transaction determination can be performed at any point prior to the step of selecting the service/transaction specific processing function in step 306.

At step 302, if no fingerprint can be created, because, for example, no communication protocol can be identified, the data can be searched using one of the processing functions 103-1 to 103-n implementing a generalised string matching algorithm. If this is the case, the data will eventually be sent to step 315, as no service/transaction specific processing function at step 306 is identified.

At step 302, it is possible to create an initial fingerprint, as described above, or to create an optimized fingerprint, as also described above, if the service is identified.

If a fingerprint is created at step 302, the data is passed on to the router 102 and the fingerprint is passed on to the LUT 105. At step 303, a lookup of the LUT 105 is performed using the fingerprint as a key in order to determine whether the data has been seen before and, if so, whether a match has previously been found for the data. Moreover, the LUT entry can also include information describing whether the data should be forwarded or defeated.

If the initial fingerprint of the data cannot be found in the LUT 105, then the initial fingerprint could advantageously be converted into an optimized fingerprint in step 304. The optimized fingerprint can be formed by either taking a selection of the types in order to create the smallest unique fingerprint (i.e. the smallest fingerprint which is not present in the Look Up Table).

At step 306, the router then determines whether a service/transaction specific processing function exists for the particular service or sequence of transactions. If a service/transaction specific processing function 103-2 does exist for the particular service/transaction, the router 102 forwards the data to that processing function 103-2 of the search block 103 and the processing function 103-2 is executed on the data at step 309.

In the first example above, the service “mailservicesite” could be associated with a given processing function 103-2. The processing function in this example could include a combination of a parser for parsing HTML pages into sections, and a string matching algorithm which is operable to search for a particular search term (e.g. “football”). Similarly and with reference to the second example given above, if a transaction specific processing function 103-3 exists for SMTP transactions, it can be used to parse the SMTP data and search for a particular string of text within the body of an email.

Completion of search step 309 will either result in a match of the particular string being found, or not. At step 312, a determination is made as to whether a match was found as a result of search step 309.

If a match is identified at step 312, then the associated fingerprint entry in LUT 105 is updated at step 310 to include information indicating that the data in respect of the fingerprint has returned a match and is therefore of interest. Optionally, the LUT entry can also be updated to include information which can be used by the router to forward the data having the same fingerprint key. Moreover, the LUT 105 can also be updated to show the total number of times a particular fingerprint has been received. Once the LUT 105 is updated at step 310, the data is forwarded at step 311, as described above, and the process ends.

If no match is found at step 312, then the LUT entry for the fingerprint of the data that has been searched will be updated, at step 313, to include information showing that the data in respect of that particular fingerprint returned no match. Optionally, the LUT entry can also be updated to include information which can be used by the router to discard (or defeat) any data having the same fingerprint key. Once the LUT 105 is updated at step 313, the data is defeated at step 314 and the process ends.

At step 306, if no service/transaction specific processing function exists for the data, then the router 102 forwards the data to a generalised processing function 103-1 which performs a generalised search at step 315, as hereinafter described. In both of the above cases, at step 312, the processing function used (either the service/transaction specific processing function of step 309 or the generalised processing function of step 315) will return a result which will indicate whether a match for a particular string of interest was found in the data.

A number of different generalised processing functions can be implemented in step 315, ranging from a simple algorithm for matching a string of characters, to more complex methods including processing functions which are configured to extract data from unknown communication streams. A particularly advantageous example of such a configurable processing function can be found disclosed in published European patent application EP2485432.

If, at step 303, the fingerprint of the data stream is found in the LUT 105, the LUT entry is used to determine whether the data associated with the fingerprint returned a match at step 305. If the LUT entry contains an indication that the data associated with the fingerprint did not return a match, the data is defeated at step 308 by the router 102. Optionally, at step 307, the LUT entry for the fingerprint can be updated to indicate that another matching fingerprint was found. Thus, each LUT entry can include a count representing the number of times that that particular fingerprint was created by the classifier 101. Each time the classifier 101 passes a fingerprint to the LUT 105, the count is incremented appropriately.

If, at step 305, the LUT entry contains an indication that the data associated with the fingerprint did return a match, data can be forwarded at step 311, as previously described. Before being forwarded at step 311, the LUT entry for that fingerprint can be updated by increasing the fingerprint count for that fingerprint by one. As will be appreciated, forwarding step 311 need not be present, because if a match exists in the LUT 105 for given data, that data will have previously been forwarded (at step 311, for example), and it may not be necessary to keep duplicate copies of the data. Instead, various embodiments may be used to simply keep a single copy of the data of interest, as well as metadata providing an indication of how many times that data has been received.

Thus, various embodiments provide a system in which fingerprint pre-classification drastically reduces the amount of data which needs to be processed. Various embodiments also provide a system in which pre-classification of data into appropriate search function streams reduces the processing power and time required to search communication data streams.

The description and drawings merely illustrate the principles of the invention. It will thus be appreciated that those skilled in the art will be able to devise various arrangements that, although not explicitly described or shown herein, embody the principles of the invention and are included within its scope.

Furthermore, all examples recited herein are principally intended to aid the reader in understanding the principles of the invention and are to be construed as being without limitation to such specifically recited examples and conditions. For example, the present disclosure will describe an embodiment of the invention with reference to the analysis of highly structured data with a high degree of replication, such as, for example HTTP, HTML, JSON, XML and JavaScript. It will however be appreciated by the skilled reader that various embodiments can also advantageously be used to search other types and forms of data.

Moreover, all statements herein reciting principles, aspects, and embodiments of the invention, as well as specific examples thereof, are intended to encompass equivalents thereof. For example, the functions of the various elements shown in the figures, including any functional blocks labelled as “processors”, may be provided through the use of dedicated hardware as well as hardware capable of executing software in association with appropriate software.

Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods.

The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. It should be appreciated by those skilled in the art that any block diagrams herein represent conceptual views of illustrative circuitry embodying the principles of the invention.

1. A method comprising:
receiving data using a communication protocol over a data communication network;
generating a fingerprint associated with the data, a format of the fingerprint being based on the communication protocol and content of the fingerprint being based on at least one characteristic of the data;
identifying the data as belonging to a particular service;
determining whether the data contains a particular pattern by comparing the fingerprint associated with the data to one or more previously generated fingerprints; and
if the one or more previously generated fingerprints do not match the fingerprint associated with the data:
selecting a pattern matching algorithm from a plurality of pattern matching algorithms based on the identified particular service, and
searching the data using the selected pattern matching algorithm.

2. The method of claim 1, wherein the step of identifying the data as belonging to the particular service includes:
extracting an indication of the particular service from the data; or
generating a unique identifier associated with the particular service using information extracted from transactions received from the particular service.

3. The method of claim 1, wherein at least one pattern matching algorithm of the plurality of pattern matching algorithms includes a parsing step and a string matching step.

4. The method of claim 1, comprising:
if the one or more previously generated fingerprints do not match the fingerprint associated with the data, storing the fingerprint associated with the data together with associated metadata in a memory, the metadata including an indication of a result of the searching step;
wherein the memory comprises the one or more previously generated fingerprints and associated previously generated metadata; and
wherein the step of determining whether the data contains the particular pattern includes comparing the fingerprint associated with the data to the one or more previously generated fingerprints stored in the memory.

5. The method of claim 4, comprising:
if one of the one or more previously generated fingerprints matches the fingerprint associated with the data, updating the associated previously generated metadata to increment a number of matching fingerprints found by 1.

6. The method of claim 4, wherein the memory comprises a Look Up Table.

7. The method of claim 1, further comprising:
if a determination is made that the data contains the particular pattern, storing the data for future reference; and
if a determination is made that the data does not contain the particular pattern, discarding the data.

8. The method of claim 1, wherein the step of identifying the data as belonging to the particular service includes the step of identifying that the data belongs to an unknown service, and
the step of selecting the pattern matching algorithm from a plurality of pattern matching algorithms based on the identified particular service further includes the step of selecting a generalised search algorithm if the data is identified as belonging to the unknown service.

9. An apparatus comprising:
data receiving means arranged to receive the data using a communication protocol over a data communication network;
fingerprint generating means arranged to generate a fingerprint associated with the data, a format of the fingerprint being based on the communication protocol and content of the fingerprint being based on at least one characteristic of the data;
identification means arranged to identify the data as belonging to a particular service;
pattern determination means arranged to determine whether the data contains a particular pattern by comparing the fingerprint associated with the data to one or more previously generated fingerprints; and
pattern matching selection means arranged to, in response to the pattern determination means determining that the data does not contain the particular pattern, select a pattern matching algorithm from a plurality of pattern matching algorithms based on the identified particular service; and
searching means arranged to, in response to the pattern matching selection means selecting the pattern matching algorithm, search the data using the selected pattern matching algorithm.

10. The apparatus of claim 9, further comprising:
storing means arranged to store the fingerprint associated with the data together with associated metadata, the metadata including an indication of a result generated by the searching means, the fingerprint associated with the data being stored in a Look Up Table comprising the one or more previously generated fingerprints and associated previously generated metadata; and
wherein the pattern determination means is arranged to compare the fingerprint associated with the data to the one or more previously generated fingerprints stored in the Look Up Table.

11. The apparatus of claim 10, further comprising:
metadata updating means arranged to, if the one or more previously generated fingerprints matches the fingerprint associated with the data, update the associated previously generated metadata to increment a number of matching fingerprints found by 1.

12. The apparatus of claim 11, further comprising:
a data router, the data router being arranged to:
if a determination is made that the data contains the particular pattern, store the data for future reference; and
if a determination is made that the data does not contain the particular pattern, discarded the data.

13. The apparatus of claim 9, wherein:
the identification means is further arranged to identify that the data belongs to an unknown service, and
pattern matching selection means is further arranged to select a generalised search algorithm if the data is identified as belonging to the unknown service by the identification means.

14. A non-transitory data storage medium comprising computer executable instructions, that when executed by a processor, cause the processor to: receive data using a communication protocol over a data communication network;
generate a fingerprint associated with the data, a format of the fingerprint being based on the communication protocol and content of the fingerprint being based on at least one characteristic of the data;
identify the data as belonging to a particular service;
determine whether the data contains a particular pattern by comparing the fingerprint associated with the data to one or more previously generated fingerprints; and
if the one or more previously generated fingerprints do not match the fingerprint associated with the data:
select a pattern matching algorithm from a plurality of pattern matching algorithms based on the identified particular service, and
search the data using the selected pattern matching algorithm.

15. The non-transitory data storage medium of claim 14, wherein the computer executable instructions, when executed by the processor, cause the processor to, in identifying that the data belongs to the particular service:
extract an indication of the particular service from the data; or
generate a unique identifier associated with the particular service using information extracted from transactions received from the particular service.

16. The non-transitory data storage medium of claim 14, wherein at least one pattern matching algorithm of the plurality of pattern matching algorithms includes a parsing step and a string matching step.

17. The non-transitory data storage medium of claim 14, wherein the computer executable instructions, when executed, cause the processor to:
if the one or more previously generated fingerprints do not match the fingerprint associated with the data, store the fingerprint associated with the data together with associated metadata in a memory, the metadata including an indication of a result of the search of the data using the selected pattern matching algorithm;
wherein the memory comprises the one or more previously generated fingerprints and associated previously generated metadata; and
wherein the processor, to determine whether the data contains the particular pattern, compares the fingerprint associated with the data to the one or more previously generated fingerprints stored in the memory.

18. The non-transitory data storage medium of claim 17, wherein the computer executable instructions, when executed, cause the processor to:
if one of the one or more previously generated fingerprints matches the fingerprint associated with the data, update the associated previously generated metadata to increment a number of matching fingerprints found by 1.

19. The non-transitory data storage medium of claim 14, wherein the computer executable instructions, when executed, cause the processor to:
if a determination is made that the data contains the particular pattern, store the data for future reference; and
if a determination is made that the data does not contain the particular pattern, discard the data.

20. The non-transitory data storage medium of claim 14, wherein the computer executable instructions, when executed, cause the processor to:
identify the data as belonging to the particular service by identifying that the data belongs to an unknown service, and
select the pattern matching algorithm from a plurality of pattern matching algorithms based on the identified particular service by selecting a generalised search algorithm if the data is identified as belonging to the unknown service.
